(19) United States
(12) Patent Application Publication
(10) Pub. No.: US 2021/0174283 A1
(43) Pub. Date: Jun. 10, 2021

(54) ADVERTISEMENT SYSTEM, ADVERTISEMENT SYSTEM CONTROL METHOD, AND SERVER

(71) Applicant: SEIKO EPSON CORPORATION, Tokyo (JP)

(72) Inventors: Tomoyuki KURATA, Matsumoto-shi (JP); Hideki KATO, Matsumoto-shi (JP); Hiroyuki KURAMOTO, Shiojiri-shi (JP)

(21) Appl. No.: 17/113,919

(22) Filed: Dec. 7, 2020

(30) Foreign Application Priority Data
Dec. 10, 2019 (JP) 2019-222737

(51) Int. Cl. G06Q 10/06; G06Q 10/08; G06Q 30/02; G06F 3/12

(52) U.S. Cl. CPC G06Q 10/06315; G06Q 10/083; G06Q 30/0241; G06F 3/1285; G06F 3/1243; G06F 3/1256; G06F 3/1208

(57) ABSTRACT

An advertisement system that issues a leaflet by a distributor printer of the distributor who distributes the leaflet on which an advertisement image is printed includes a processing unit that causes a same model printer whose model is the same as a model of the distributor printer to issue, as a sample of the leaflet, a print sample on which the advertisement image is printed, and that transmits a requests for delivering the print sample issued by the same model printer to an advertiser.

The present application is based on, and claims priority from JP Application Serial Number 2019-222737, filed Dec. 10, 2019, the disclosure of which is hereby incorporated by reference herein in its entirety.

### BACKGROUND

### 1. Technical Field

The present disclosure relates to an advertisement system, a method of controlling the advertisement system, and a server.

### 2. Related Art

In the related art, a technique of issuing an advertising medium by a printing apparatus is known. For example, JP-A-2005-259018 discloses a system in which print information is generated based on advertisement design information, printing based on the generated print information is performed at a distribution base of an advertising medium, and a leaflet is issued at the distribution base.

However, the system described in JP-A-2005-259018 has a problem that the advertiser cannot validate the print quality of the leaflet.

### SUMMARY

According to an aspect of the present disclosure, in an advertisement system that issues an advertising medium by a first printing apparatus of a distributor who distributes the advertising medium on which an advertisement image is printed, the advertisement system includes a processing unit that causes a same model printing apparatus whose model is the same as a model of the first printing apparatus to issue, as a sample of the advertising medium, printed matter on which the advertisement image is printed, and that delivers the printed matter issued by the same model printing apparatus to an advertiser.

According to another aspect of the present disclosure, in a method of controlling an advertisement system for issuing an advertising medium by a first printing apparatus of a distributor who distributes the advertising medium on which an advertisement image is printed, the method includes causing a same model printing apparatus whose model is the same as a model of the first printing apparatus to issue, as a sample of the advertising medium, printed matter on which the advertisement image is printed, and delivering the printed matter issued by the same model printing apparatus to an advertiser.

According to still another aspect of the present disclosure, in a server that issues an advertising medium by a first printing apparatus of a distributor who distributes the advertising medium on which an advertisement image is printed, the server includes a processing unit that causes a same model printing apparatus whose model is the same as a model of the first printing apparatus to issue, as a sample of the advertising medium, printed matter on which the advertisement image is printed, and that delivers the printed matter issued by the same model printing apparatus to an advertiser.

### BRIEF DESCRIPTION OF THE DRAWINGS

FIG. 1 is a diagram showing a configuration of an advertisement system.

FIGS. 2A to 2C are a diagram showing a configuration of each device included in the advertisement system.

FIG. 3 is a diagram showing an example of a distributor management database.

FIG. 4 is a diagram showing an example of an advertiser management database.

FIG. 5 is a diagram showing an example of a request information management database.

FIG. 6 is a diagram showing an example of a delivery company management database.

FIG. 7 is a flowchart showing the operation of the advertisement system.

FIG. 8 is a diagram showing an example of a print sample.

FIG. 9 is a flowchart showing the operation of the advertisement system.

FIG. 10 is a flowchart showing the operation of the advertisement system.

### DESCRIPTION OF EXEMPLARY EMBODIMENTS

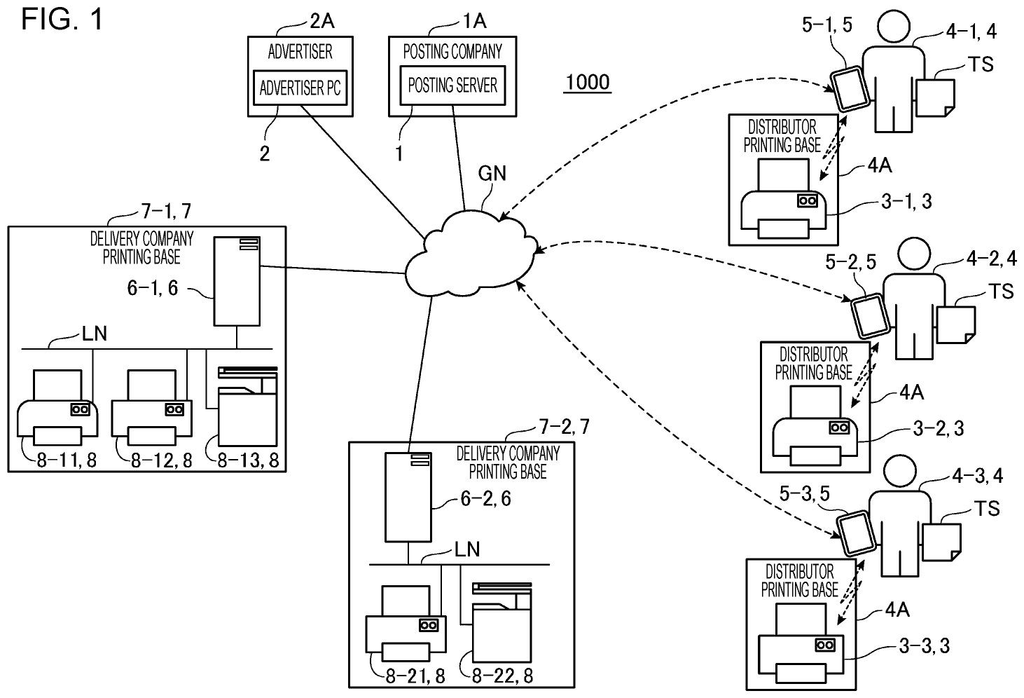

FIG. 1 is a diagram showing a configuration of an advertisement system 1000.

The advertisement system 1000 is a system used by a posting company 1A. The posting company 1A is a company that performs a business related to distribution of a leaflet TS in which the advertisements of products and services of an advertiser 2A are placed. The leaflet TS is a diagram showing an example of an advertising medium.

As shown in FIG. 1, the advertisement system 1000 includes a posting server 1. The posting server 1 corresponds to an example of a server. The posting server 1 is a server apparatus managed by the posting company 1A and is connected to a global network GN.

In each figure, the posting server 1 is represented by one block, but this does not necessarily mean that the posting server 1 is configured by a single server apparatus. For example, the posting server 1 may be configured to include a plurality of server apparatuses having different processing contents.

As shown in FIG. 1, the advertisement system 1000 includes a distributor printer 3. The distributor printer 3 corresponds to an example of a first printing apparatus. The distributor printer 3 is an ink jet printing apparatus and is used by a distributor 4 who distributes the leaflet TS by concluding a predetermined contract with the posting company 1A. The distributor printer 3 is installed at a distributor printing base 4A, which is the base where the distributor 4 issues the leaflet TS. The distributor printing base corresponds to an example of a first base. The distributor printing base is, for example, the distributor's residence. The distributor printer 3 may be the property of the distributor 4 or may be lent by the posting company 1A.

In FIG. 1, three distributors 4 are illustrated. A distributor 4-1 uses a distributor printer 3-1. A distributor 4-2 uses a distributor printer 3-2. A distributor 4-3 uses a distributor printer 3-3. In this embodiment, the distributor printers 3-1 and 3-2 are of the same model to each other. The distributor printer 3-3 has a model different from that of the distributor printers 3-1 and 3-2. Note that the number of distributors 4 is merely an example, and may be larger or smaller.

As shown in FIG. 1, the advertisement system 1000 includes a tablet terminal 5 used by the distributor 4. The tablet terminal 5 is, for example, a tablet-type terminal device having a touch panel 53 on the main surface thereof, and communicates with the distributor printer 3 to control the distributor printer 3. Further, the tablet terminal 5 is connected to the global network GN to communicate with the posting server 1. The tablet terminal 5 used by the distributor 4 may be the property of the distributor 4 or may be lent by the posting company 1A. Further, in the present embodiment, the case where the one distributor printer 3 communicates with the one tablet terminal 5 is illustrated, but the number of the distributor printers 3 communicating with the tablet terminal 5 may be plural.

In this embodiment, the distributor 4-1 operates a tablet terminal 5-1 to issue the leaflet TS with the distributor printer 3-1. Further, the distributor 4-2 operates a tablet terminal 5-2 to issue the leaflet TS with the distributor printer 3-2. Further, the distributor 4-3 operates a tablet terminal 5-3 to issue the leaflet TS with the distributor printer 3-3.

As shown in FIG. 1, an advertiser PC 2 which is a personal computer (PC) operated by the advertiser 2A is connected to the global network GN. A browser 220B is installed in advance in the advertiser PC 2. The advertiser 2A opens the browser 220B installed in the advertiser PC 2, accesses a Web page provided by the posting company 1A, and requests the posting company 1A to distribute the leaflet TS via the Web page. Note that the number of advertiser PCs 2 connected to the global network GN is merely an example, and is not limited to one, and may be plural.

As shown in FIG. 1, a delivery company server 6 is connected to the global network GN. The delivery company server 6 is a server apparatus managed by the delivery company. The delivery company is a company that performs a business of delivering printed matter on which an advertisement placed on the leaflet TS is printed to the advertiser 2A as a sample of the leaflet TS to be distributed by the distributor 4. In the following description, the printed matter will be referred to as a “print sample” and will be denoted by “SP”.

In this embodiment, delivery company servers 6-1 and 6-2 are connected to the global network GN. The delivery company server 6-1 is installed at a delivery company printing base 7-1, which is the base where the delivery company issues the print sample SP. The delivery company server 6-2 is installed at a delivery company printing base 7-2, which is the base where the delivery company issues the print sample SP. In the following description, the delivery company printing bases 7-1 and 7-2 will be collectively referred to as a “delivery company printing base 7” without particular distinction. The delivery company printing base 7 corresponds to an example of a second base. Examples of the delivery company printing base 7 are a business office of the delivery company, a printing factory of the delivery company, and a head office of the delivery company. In FIG. 1, the delivery companies at the delivery company printing bases 7-1 and 7-2 may be different from each other or the same.

A delivery company printer 8 is installed at each of the delivery company printing bases 7. The delivery company printer 8 corresponds to an example of a second printing apparatus. The delivery company printer 8 is an ink jet printing apparatus, and is used by a delivery company. The delivery company printer 8 may be the property of the delivery company or may be lent by the posting company 1A to the delivery company.

Delivery company printers 8-11, 8-12, and 8-13 are installed at the delivery company printing base 7-1. The delivery company printers 8-11, 8-12, and 8-13 are connected to a local network LN installed at the delivery company printing base 7-1 and communicate with the delivery company server 6-1. The delivery company printers 8-11, 8-12, and 8-13 are of the different models to each other. The delivery company printer 8-11 is of the same model as the distributor printers 3-1 and 3-2. The delivery company printer 8-12 is of the same model as the distributor printer 3-3.

Delivery company printers 8-21 and 8-22 are installed at the delivery company printing base 7-2. The delivery company printers 8-21 and 8-22 are connected to the local network LN installed at the delivery company printing base 7-2 and communicate with the delivery company server 6-2. The delivery company printers 8-21 and 8-22 are of different models to each other. The delivery company printer 8-21 is of the same model as the distributor printer 3-3. The delivery company printer 8-22 has a model different from that of the distributor printers 3-1, 3-2, and 3-3.

In the following description, a printing apparatus whose model is the same as a model of the distributor printer 3 is referred to as a “same model printer”. The same model printer corresponds to an example of the same model printing apparatus. In this embodiment, the same model printer with respect to the distributor printers 3-1 and 3-2 is the delivery company printer 8-11. Further, the same model printer with respect to the distributor printer 3-3 is the delivery company printers 8-12 and 8-22.

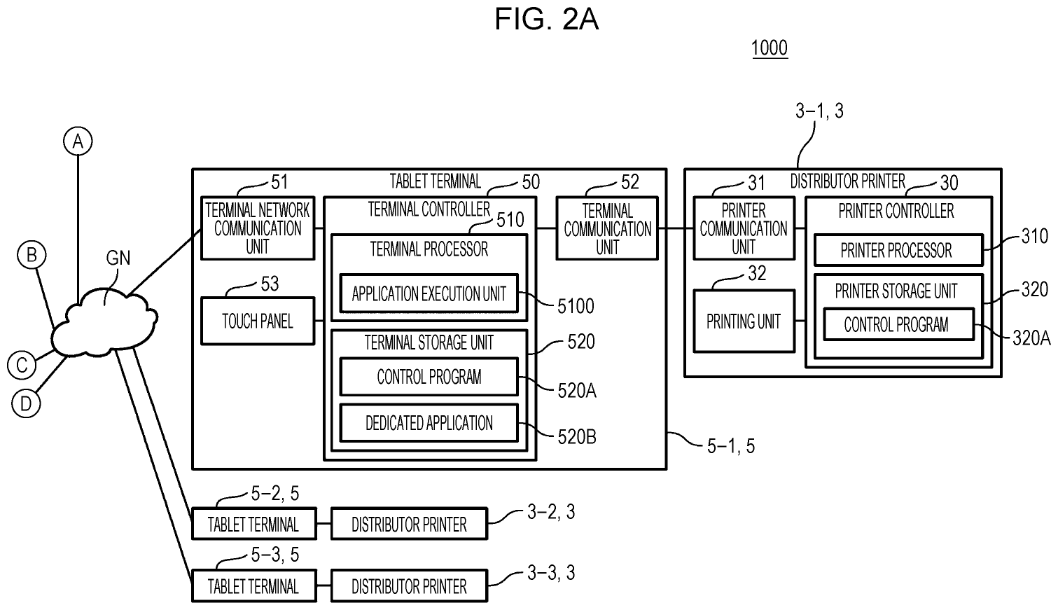

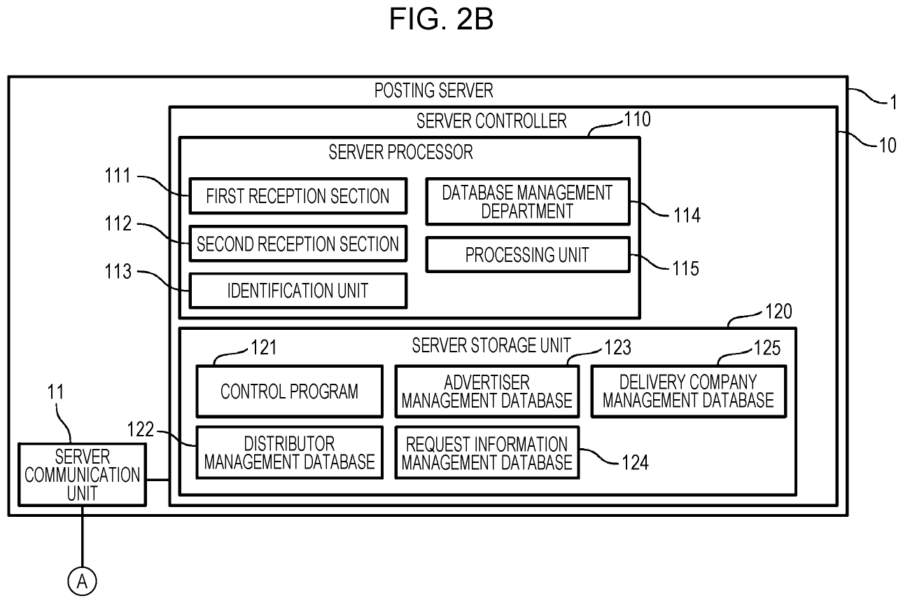

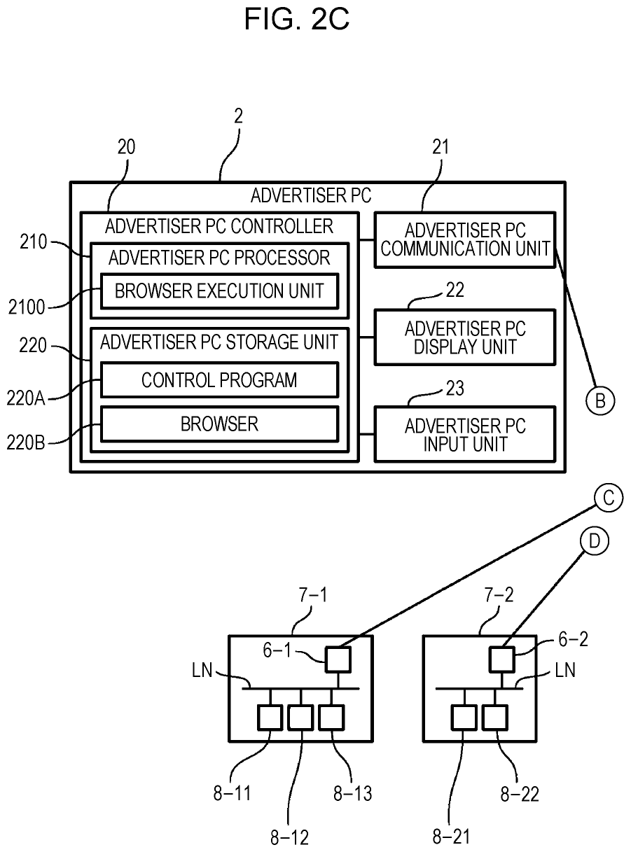

FIGS. 2A to 2C are a block diagram showing a functional configuration of each device included in the advertisement system 1000. In particular, FIGS. 2A to 2C shows a functional configuration of the posting server 1, the advertiser PC 2, the distributor printer 3, and the tablet terminal 5 among the devices included in the advertisement system 1000.

First, the tablet terminal 5 will be described. The tablet terminal 5 includes a terminal controller 50, a terminal network communication unit 51, a terminal communication unit 52, and the touch panel 53.

The terminal controller 50 includes a terminal processor 510 that is a processor, such as a CPU and an MPU, that executes programs, and a terminal storage unit 520, and controls respective units of the tablet terminal 5. The terminal controller 50 executes various processes in cooperation with hardware and software so that the terminal processor 510 reads a control program 520A stored in the terminal storage unit 520 to execute the processes. A dedicated application program is installed in advance in the tablet terminal 5. In the following description, the dedicated application program is simply referred to as a “dedicated application” and is denoted by “520B”. The dedicated application 520B is an application program that is read from the terminal storage unit 520 and executed by the terminal processor 510 to cause the terminal controller 50 to function as an application execution unit 5100. The function of the application execution unit 5100 will be described later.

The terminal storage unit 520 has a storage area in which a program to be executed by the terminal processor 510 and data processed by the terminal processor 510 are stored. The terminal storage unit 520 stores the control program 520A to be executed by the terminal processor 510, the dedicated application 520B, and other various pieces of data. The terminal storage unit 520 has a non-volatile storage area in which programs and data are stored in a nonvolatile manner. In addition, the terminal storage unit 520 may include a volatile storage area, and may constitute a work area in which a program executed by the terminal processor 510 and data to be processed are temporarily stored.

The terminal network communication unit 51 includes communication hardware according to a predetermined communication standard, and communicates with the posting server 1 according to a predetermined communication standard under the control of the terminal controller 50.

The terminal communication unit 52 is composed of communication hardware according to a predetermined communication standard, and communicates with the distributor printer 3 under the control of the terminal controller 50. The communication standard of communication performed between the tablet terminal 5 and the distributor printer 3 is a wireless communication standard in this embodiment, but may be a wired communication standard.

The touch panel 53 includes a display panel such as a liquid crystal display panel and a touch sensor that is provided so as to overlap with or provided integrally with the display panel. The display panel displays various images under the control of the terminal controller 50. The touch sensor detects a touch operation to output the result to the terminal controller 50. The terminal controller 50 executes a process corresponding to the touch operation based on the input from the touch sensor.

As described above, the terminal controller 50 functions as the application execution unit 5100. Upon receiving the leaflet distribution request notification from the posting server 1, the application execution unit 5100 transmits the leaflet print data included in the leaflet distribution request notification to the distributor printer 3. The leaflet print data is data for instructing the distributor printer 3 to issue the leaflet TS, and includes advertisement image data 1243, which will be described later, and various commands related to printing.

Next, the distributor printer 3 will be described. The distributor printer 3 includes a printer controller 30, a printer communication unit 31, and a printing unit 32.

The printer controller 30 includes a printer processor 310, which is a processor, such as a CPU and an MPU, that executes programs, and a printer storage unit 320, and controls respective units of the distributor printer 3. The printer controller 30 executes various processes in cooperation with hardware and software so that the printer processor 310 reads a control program 320A stored in the printer storage unit 320 to execute the processes.

The printer storage unit 320 has a storage area in which a program to be executed by the printer processor 310 and data processed by the printer processor 310 are stored. The printer storage unit 320 stores the control program 320A executed by the printer processor 310 and other various pieces of data. The printer storage unit 320 has a non-volatile storage area in which programs and data are stored in a nonvolatile manner. Further, the printer storage unit 320 may include a volatile storage area, and may constitute a work area in which a program to be executed by the printer processor 310 and data to be processed are temporarily stored.

The printer communication unit 31 is composed of communication hardware according to a predetermined communication standard, and communicates with the tablet terminal 5 under the control of the printer controller 30.

The printing unit 32 has a configuration related to a printing system including an ink jet head that ejects ink onto a print medium, a carriage for scanning the ink jet head in the scanning direction, a carriage drive motor for driving the carriage, a transport unit that transports a print medium, a supply mechanism that supplies the ink to the ink jet head, and the like. The printing unit 32 prints an image on a print medium under the control of the printer controller 30. The printing unit 32 of the present embodiment prints an advertisement image KG on the print medium based on the leaflet print data transmitted from the posting server 1 via the tablet terminal 5, and issues the leaflet TS.

Next, the advertiser PC 2 will be described. The advertiser PC 2 includes an advertiser PC controller 20, an advertiser PC communication unit 21, an advertiser PC display unit 22, and an advertiser PC input unit 23.

The advertiser PC controller 20 includes an advertiser PC processor 210, which is a processor, such as a CPU and an MPU, that executes programs, and an advertiser PC storage unit 220, and controls respective units of the advertiser PC 2. The advertiser PC controller 20 executes various processes in cooperation with hardware and software so that the advertiser PC processor 210 reads a control program 220A stored in the advertiser PC storage unit 220 to execute the processes. The browser 220B is installed in advance in the advertiser PC 2. The browser 220B is read from the advertiser PC storage unit 220 by the advertiser PC processor and executed to cause the advertiser PC controller 20 to function as a browser execution unit 2100. The function of the browser execution unit 2100 will be described later.

The advertiser PC storage unit 220 has a storage area in which a program executed by the advertiser PC processor 210 and data processed by the advertiser PC processor 210 are stored. The advertiser PC storage unit 220 stores the control program 220A executed by the advertiser PC processor 210, the browser 220B, and other various pieces of data. The advertiser PC storage unit 220 has a non-volatile storage area in which programs and data are stored in a nonvolatile manner. Further, the advertiser PC storage unit 220 may include a volatile storage area, and may constitute a work area in which a program executed by the advertiser PC processor 210 and data to be processed are temporarily stored.

The advertiser PC communication unit 21 includes communication hardware according to a predetermined communication standard, and communicates with the posting server 1 according to a predetermined communication standard under the control of the advertiser PC controller 20.

The advertiser PC display unit 22 includes a display panel, and displays various pieces of information on the display panel under the control of the advertiser PC controller 20.

The advertiser PC input unit 23 includes a keyboard, a mouse, and another input section, and detects a user operation on the input section to output the detected operation to the advertiser PC controller 20. The advertiser PC controller 20 executes a process corresponding to the user's operation on the input section based on the input from the advertiser PC input unit 23.

As described above, the advertiser PC controller 20 functions as the browser execution unit 2100. The browser execution unit 2100 accesses the URL of a Web page for requesting the distribution of the leaflet TS and receives an HTML file for displaying the Web page from the posting server 1 through the advertiser PC communication unit 21. The browser execution unit 2100 displays the Web page on the advertiser PC display unit 22 based on the received HTML file.

The browser execution unit 2100 receives the input of the distribution condition of the leaflet TS through the Web page displayed by the advertiser PC display unit 22. The distribution conditions input to the Web page includes the distribution desired period that is a period in which the advertiser 2A desires the distributor to distribute the leaflet TS, the desired number of distribution sheets that is the number of sheets, of the leaflet TS, which the advertiser 2A desires the distributor to distribute in the distribution desired period, and the distribution desired area that is an area in which the advertiser 2A desires the distributor to distribute of the leaflet TS. The browser execution unit 2100 receives the input of an advertiser ID 1231, and the advertisement image data 1243 in addition to the distribution condition of the leaflet TS through the Web page displayed by the advertiser PC display unit 22.

Upon receiving the inputs of the distribution condition of the leaflet TS, the advertiser ID 1231, and the advertisement image data 1243, the browser execution unit 2100 transmits request information 1242 to the posting server 1 through the advertiser PC communication unit 21. The browser execution unit 2100 makes an advertisement request to the posting server 1 by transmitting the request information 1242. The advertisement request is a request, for distributing the leaflet TS, that the advertiser 2A makes to the posting server 1. The request information 1242 transmitted as the advertisement request includes information indicating the distribution condition received by the browser execution unit 2100, the advertiser ID 1231, and the advertisement image data 1243.

The browser execution unit 2100 receives the input of information related to the validation result of the print sample SP through the Web page displayed by the advertiser PC display unit 22. The information related to the validation result of the print sample SP includes the advertiser ID 1231, sample identification information SPJ for identifying the print sample SP, and the permission information indicating the permission of the distribution of the leaflet TS, or the non-permission information indicating the non-permission of the distribution of the leaflet TS. Upon receiving the input of the information about the validation result of the print sample SP, the browser execution unit 2100 transmits the validation result information including the information received by the advertiser PC communication unit 21 to the posting server 1.

Next, the posting server 1 will be described. The posting server 1 includes a server controller 10 and a server communication unit 11.

The server controller 10 includes a server processor 110, which is a processor, such as a CPU and an MPU, that executes programs, and a server storage unit 120, and controls respective units of the posting server 1. The server storage unit 120 corresponds to an example of the storage unit. The server controller 10 executes various processes in cooperation with hardware and software so that the server processor 110 reads a control program 121 stored in the server storage unit 120 and executes the processes. The server processor 110 reads out and executes the control program 121, so that the server controller 10 functions as a first reception unit 111, a second reception unit 112, an identification unit 113, a database management unit 114, and a processing unit 115. Details of these functional units will be described later.

The server storage unit 120 has a storage area in which a program executed by the server processor 110 and data processed by the server processor 110 are stored. The server storage unit 120 stores the control program 121 executed by the server processor 110, a distributor management database 122, an advertiser management database 123, a request information management database 124, a delivery company management database 125, and other various pieces of data. The server storage unit 120 has a non-volatile storage area in which programs and data are stored in a nonvolatile manner. Further, the server storage unit 120 may include a volatile storage area, and may constitute a work area in which a program to be executed by the server processor 110 and data to be processed are temporarily stored.

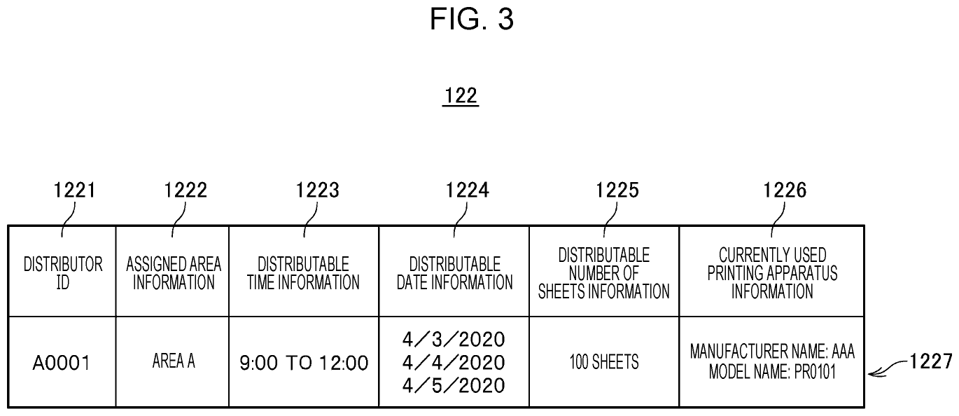

FIG. 3 is a diagram showing an example of the distributor management database 122. The distributor management database 122 is a database that stores, as a record, distributor information 1227, which is information about the distributor 4. One record of the distributor management database 122, that is, the one distributor information 1227 stored in the distributor management database 122 includes a distributor ID 1221, assigned area information 1222, distributable time information 1223, distributable date information 1224, distributable number of sheets information 1225, and currently used printing apparatus information 1226.

The distributor ID 1221 is identification information for identifying the distributor 4, and is assigned to the distributor 4 when a record is newly stored in the distributor management database 122, for example.

The assigned area information 1222 is information indicating an assigned area in which the distributor 4 distributes the leaflet TS.

The distributable time information 1223 is information indicating the distributable time, which is a time at which the distributor 4 can distribute the leaflet TS in one day.

The distributable date information 1224 is information indicating a distributable date that is a date on which the distributor 4 can distribute the leaflet TS in a predetermined period.

The distributable number of sheets information 1225 is information indicating the distributable number of sheets, which is the number of sheets of the leaflet TS that the distributor 4 can distribute. The distributable number of sheets indicated by the distributable number of sheets information 1225 is the number of sheets of the leaflet TS that can be distributed at the distributable time indicated by the distributable time information 1223. The distributable number of sheets information 1225 indicates the distributable time indicated by the distributable time information 1223 and the distributable number of sheets according to the combination of the manufacturer name of the distributor printer 3 and the model name of the distributor printer 3 indicated by the currently used printing apparatus information 1226.

The currently used printing apparatus information 1226 is information about the distributor printer 3 used by the distributor 4 indicated by the distributor ID 1221 of the same record. The information about the distributor printer 3 indicates the combination of the manufacturer name of the distributor printer 3 and the model name of the distributor printer 3.

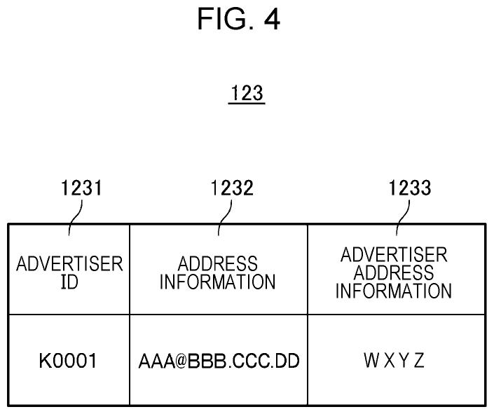

FIG. 4 is a diagram showing an example of the advertiser management database 123. As shown in FIG. 4, one record of the advertiser management database 123 includes the advertiser ID 1231, address information 1232, and advertiser address information 1233.

The advertiser ID 1231 is identification information for identifying the advertiser 2A, and is notified to the advertiser 2A in advance by a predetermined method.

The address information 1232 is address information for transmitting predetermined information to the advertiser PC 2, that is, for example, information such as am e-mail address.

The advertiser address information 1233 is information indicating the address of the advertiser 2A. The address of the advertiser 2A corresponds to an example of the location of the advertiser 2A.

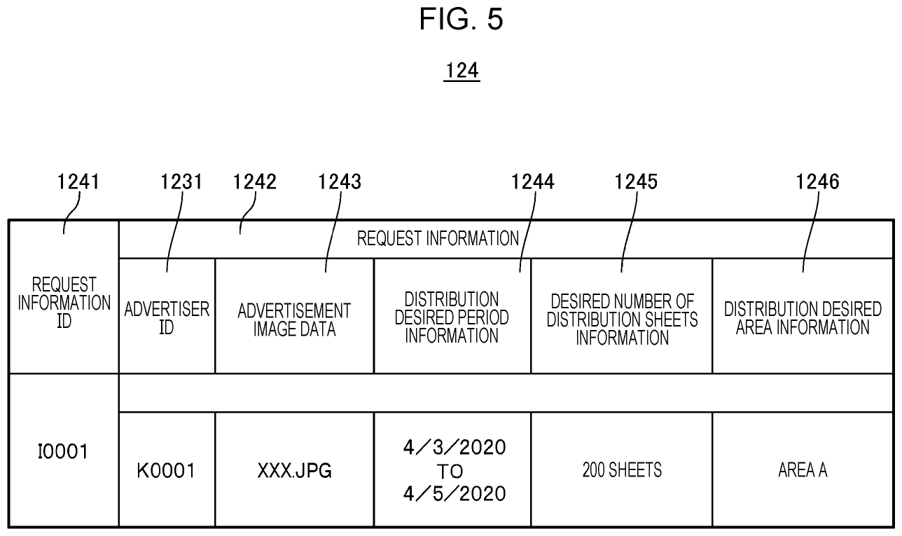

FIG. 5 is a diagram showing an example of the request information management database 124. As shown in FIG. 5, one record of the request information management database 124 includes a request information ID 1241 and the request information 1242.

The request information ID 1241 is identification information for identifying the request information 1242 received from the advertiser PC 2.

When the first reception unit 111 receives the request information 1242 from the advertiser PC 2, the database management unit 114 of the server controller 10 generates the request information ID 1241 to associates the generated request information ID 1241 with the received request information 1242. Then, the database management unit 114 stores, in the request information management database 124, a record in which the request information 1242 is associated with the request information ID 1241.

The request information 1242 includes the advertiser ID 1231, the advertisement image data 1243, distribution desired period information 1244, desired number of distribution sheets information 1245, and distribution desired area information 1246.

The advertisement image data 1243 is image data of an advertisement image showing an advertisement to be placed on the leaflet TS. The advertisement image data 1243 is generated by a predetermined application program installed in the advertiser PC 2.

The distribution desired period information 1244 is information indicating a distribution desired period.

The desired number of distribution sheets information 1245 is information indicating the desired number of distribution sheets.

The distribution desired area information 1246 is information indicating a distribution desired area.

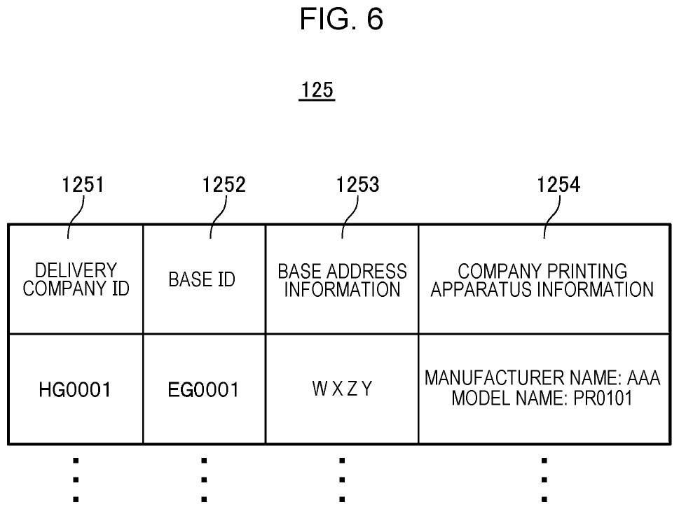

FIG. 6 is a diagram showing an example of the delivery company management database 125. As shown in FIG. 6, one record of the delivery company management database 125 includes a delivery company ID 1251, a base ID 1252, base address information 1253, and company printing apparatus information 1254.

The delivery company ID 1251 is identification information for identifying the delivery company.

The base ID 1252 is identification information for identifying the delivery company printing base 7 of the delivery company indicated by the delivery company ID 1251 of the same record.

The base address information 1253 is information indicating the address of the delivery company printing base 7 indicated by the base ID 1252 of the same record.

The company printing apparatus information 1254 includes information about the delivery company printer 8 installed at the delivery company printing base 7 indicated by the base ID 1252 of the same record. The information about the delivery company printer 8 indicates the combination of the manufacturer name of the delivery company printer 8 and the model name of the delivery company printer 8. For example, when the base ID 1252 indicates the delivery company printing base 7-1, the associated company printing apparatus information 1254 indicates one of the combination of the manufacturer name of the delivery company printer 8-11 and the model name of the delivery company printer 8-11, the combination of the manufacturer name of the delivery company printer 8-12 and the model name of the delivery company printer 8-12, and the combination of the manufacturer name of the delivery company printer 8-13 and the model name of the delivery company printer 8-13.

Returning to the description of FIGS. 2A to 2C, the server communication unit 11 includes communication hardware according to a predetermined communication standard, and communicates with a device connected to the global network GN according to the predetermined communication standard under the control of the server controller 10. The devices connected to the global network GN here include the advertiser PC 2, the tablet terminal 5, and the delivery company server 6.

As described above, the server controller 10 functions as the first reception unit 111, the second reception unit 112, the identification unit 113, the database management unit 114, and the processing unit 115.

The first reception unit 111 receives the advertisement request from the advertiser 2A by receiving the request information 1242 from the advertiser PC 2 through the server communication unit 11. The first reception unit 111 outputs the received request information 1242 to the database management unit 114. The database management unit 114 generates a record including the request information ID 1241 output by the first reception unit 111 to store the generated record in the request information management database 124.

The second reception unit 112 receives permission of a distribution of the leaflet TS by receiving the validation result information including the permission information from the advertiser PC 2 through the server communication unit 11. In addition, the second reception unit 112 receives non-permission of a distribution of the leaflet TS by receiving the validation result information including the non-permission information from the advertiser PC 2 through the server communication unit 11.

The identification unit 113 identifies the distributor information 1227 that satisfies the distribution condition of the advertiser 2A from the distributor management database 122. Note that identifying the distributor information 1227 means identifying the distributor 4.

The database management unit 114 appropriately updates various kinds of information included in the record with respect to the record that each of the distributor management database 122, the advertiser management database 123, the request information management database 124, and the delivery company management database 125 stores. In addition, the database management unit 114 creates records to be stored in various databases, stores the created records, and deletes the records from the database.

The processing unit 115 causes the delivery company to issue the print sample SP and causes the delivery company to deliver the print sample SP to the advertiser 2A. Further, the processing unit 115 generates leaflet print data and a leaflet distribution request notification to transmit the generated leaflet distribution request notification to the tablet terminal 5 through the server communication unit 11.

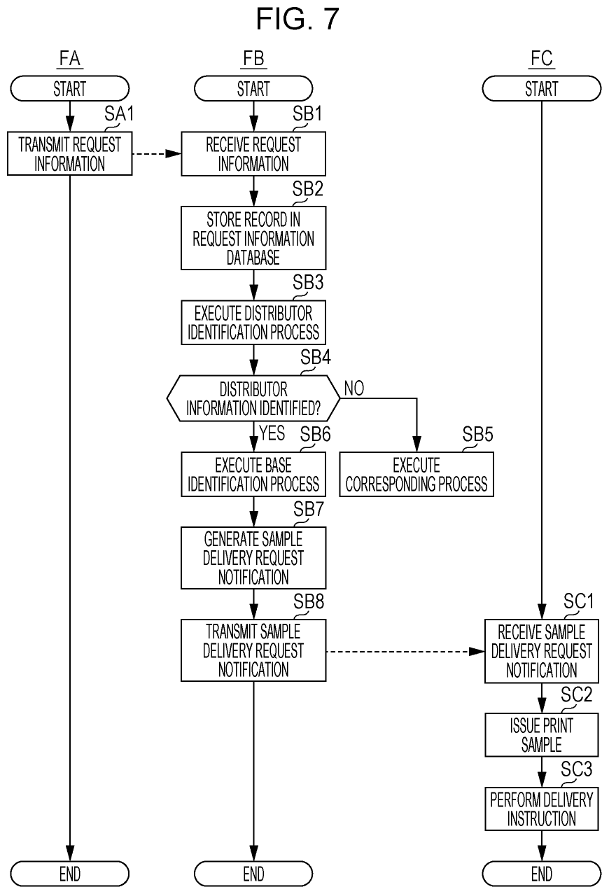

Next, the operation of the advertisement system 1000 will be described. First, the operation of delivering the print sample SP to the advertiser 2A will be described with reference to FIG. 7.

FIG. 7 is a flowchart showing the operation of the advertisement system 1000. In FIG. 7, a flowchart FA shows the operation of the advertiser PC 2. Further, a flowchart FB shows the operation of the posting server 1. Further, a flowchart FC shows the operation of the delivery company server 6.

As shown in the flowchart FA, the browser execution unit 2100 of the advertiser PC 2 transmits the request information 1242 to the posting server 1 through the advertiser PC communication unit 21 according to the operation of the advertiser 2A (step SA1).

As shown in the flowchart FB, the first reception unit 111 of the posting server 1 receives the request information 1242 from the advertiser PC 2 through the server communication unit 11 (step SB1).

Next, the database management unit 114 generates a record including the request information 1242 to stores the generated record in the request information management database 124 (step SB2).

Next, the identification unit 113 executes the distributor identification process based on the record stored in step SB2 (step SB3).

In the distributor identification process, the identification unit 113 identifies the distributor 4 who satisfies the distribution condition indicated by the request information 1242 of the record stored in step SB2.

Here, step SB3 will be described in detail. In step SB3, the identification unit 113 performs the three identification processes in three stages to identify the distributor information 1227 from the distributor management database 122.

### Identification Process 1

In step SB3, the identification unit 113 first performs the identification process 1. In the identification process 1, the identification unit 113 identifies, from the distributor management database 122, the distributor information 1227 including the assigned area information 1222 indicating the assigned area including the distribution desired area indicated by the distribution desired area information 1246 of the record stored in step SB2.

For example, it is assumed that the distributor information 1227 of the distributors 4-1 and 4-2 includes the assigned area information 1222 indicating an area A. Further, it is assumed that the distributor information 1227 of the distributor 4-3 includes the assigned area information 1222e indicating an area B. Then, it is assumed that the distribution desired area indicated by the distribution desired area information 1246 of the record stored in step SB2 indicates the “area A”. In this case, the identification unit 113 identifies the distributor information 1227 of the distributors 4-1 and 4-2 from the distributor management database 122 in the identification process 1.

### Identification Process 2

After performing the identification process 1 in step SB3, the identification unit 113 continuously performs the identification process 2. The identification unit 113 identifies, from the distributor information 1227 identified in the identification process 1, the distributor information 1227 having the distributable date information 1224 indicating the distributable date corresponding to at least part of the distribution desired period indicated by the distribution desired period information 1244 of the record stored in step SB2.

For example, it is assumed that the identification unit 113 identifies the distributor information 1227 of the distributors 4-1, 4-2, and 4-3 in the identification process 1. In addition, it is assumed that the distributor information 1227 of the distributors 4-1 and 4-2 includes the distributable date information 1224 indicating Apr. 3, 2020, Apr. 4, 2020, and Apr. 5, 2020. Further, it is assumed that the distributor information 1227 of the distributor 4-3 includes the distributable date information 1224 indicating Apr. 6, 2020. Then, it is assumed that the distribution desired period indicated by the distribution desired period information 1244 of the record stored in step SB2 indicates three days from Apr. 3, 2020 to Apr. 5, 2020. In this case, the distributable dates of the distributors 4-1 and 4-2 correspond to at least part of the distribution desired period. Therefore, in this case, the identification unit 113 identifies the distributor information 1227 of the distributors 4-1 and 4-2 in the identification process 2.

### Identification Process 3

After performing the identification process 2 in step SB3, the identification unit 113 continuously performs the identification process 3. The identification unit 113 identifies the distributor information 1227 from the distributor information 1227 identified in the identification process 2 so that the total distributable number of sheets exceeds the desired number of distribution sheets indicated by the desired number of distribution sheets information 1245 of the record stored in step SB2.

For example, it is assumed that the identification unit 113 identifies the distributor information 1227 of the distributors 4-1, 4-2, and 4-3 in the identification process 2. Further, it is assumed that the distributor information 1227 of the distributors 4-1, 4-2, and 4-3 each includes the distributable number of sheets information 1225 indicating 100 sheets. Then, it is assumed that the desired number of distribution sheets indicated by the desired number of distribution sheets information 1245 of the record stored in step SB2 is 250. In this case, the identification unit 113 identifies the distributor information 1227 of the distributors 4-1, 4-2, and 4-3 in the identification process 3. When the desired number of distribution sheets is 200, for example, the identification unit 113 identifies two pieces of the distributor information 1227 from the distributor information 1227 of the distributors 4-1, 4-2 and 4-3 based on a predetermined standard.

Returning to the description of the flowchart FB, the identification unit 113 determines whether the distributor information 1227 satisfying the distribution condition is identified in the distributor identification process (step SB4).

When the distributor information 1227 cannot be identified in the identification process 1 of the distributor identification process, the identification unit 113 makes a negative determination in step SB4. Further, when the distributor information 1227 cannot be identified in the identification process 2 of the distributor identification process, the identification unit 113 makes a negative determination in step SB4. Further, when the distributor information 1227 that exceeds the desired number of distribution sheets cannot be identified in the identification process 3 of the distributor identification process, the identification unit 113 makes a negative determination in step SB4. On the other hand, when the distributor information 1227 that exceeds the desired number of distribution sheets is identified in the identification process 3 of the distributor identification process, the identification unit 113 makes an affirmative determination in step SB4.

When it is determined that the distributor information 1227 satisfying the distribution condition cannot be identified (step SB4: NO), the identification unit 113 executes the corresponding process (step SB5). An example of the corresponding process includes a process of notifying the advertiser 2A that the leaflet TS that meets the distribution condition cannot be distributed can not be distributed.

On the other hand, when the identification unit 113 determines that the distributor information 1227 satisfying the distribution condition is identified (step SB4: YES), the processing unit 115 performs the base identification process (step SB6). The base identification process is a process of identifying the delivery company printing base 7 that issues the print sample SP based on the record stored in step SB2, and specifically, a process of identifying the record from the delivery company management database 125.

Here, step SB6 will be described in detail. In the description of step SB6, the case where the one distributor information 1227 is identified in the distributor identification process and the case where the plurality of distributor information 1227 is identified in the distributor identification process will be described separately. When one distributor information is identified

The processing unit 115 identifies the record having the company printing apparatus information 1254 indicating the combination same as the combination indicated by the currently used printing apparatus information 1226 of the distributor information 1227 identified in the distributor identification process.

For example, it is assumed that the distributor information 1227 of the distributor 4-1 is identified in the distributor identification process. As described above, the printer whose model is the same as a model of the distributor printer 3-1 of the distributor 4-1 is the delivery company printer 8-11 installed at the delivery company printing base 7-1. Therefore, the base ID 1252 indicating the delivery company printing base 7-1 is associated with the company printing apparatus information 1254 including the information same as the information about the printer of the distributor printer 3-11. Therefore, in this case, the processing unit 115 identifies the record of the delivery company printing base 7-1 from the delivery company management database 125 in the base identification process.

When a plurality of records can be identified from the delivery company management database 125, the processing unit 115 further identifies the record of the delivery company printing base 7 closest to the address of the advertiser 2A from the plurality of the identified records.

For example, it is assumed that the distributor information 1227 of the distributor 4-3 is identified in the distributor identification process. As described above, the printer whose model is the same as a model of the distributor printer 3-3 of the distributor 4-3 is the delivery company printer 8-12 installed at the delivery company printing base 7-1 and the delivery company printer 8-21 installed at the delivery company printing base 7-2. Therefore, the processing unit 115 identifies the record of each of the delivery company printing bases 7-1 and 7-2 from the delivery company management database 125. In this case, the processing unit 115 identifies, based on the base address information 1253 and the advertiser address information 1233 associated with the advertiser ID 1231 of the record identified in step SB2, the record of the delivery company printing base 7 indicating the address closest to the address of the advertiser 2A. When the delivery company printing base 7-2 is closer to the address of the advertiser 2A than the delivery company printing base 7-1, the processing unit 115 identifies the record of the delivery company printing base 7-2. When a plurality of pieces of distributor information is identified

The processing unit 115 identifies the record of the company printing apparatus information 1254 indicating the combination same as the combination indicated by the currently used printing apparatus information 1226 for each piece of the distributor information 1227 identified in the distributor identification process.

For example, it is assumed that the distributor information 1227 of each of the distributors 4-1 and 4-2 is identified in the distributor identification process. As described above, the printer whose model is the same as a model of the distributor printer 3-1 of the distributor 4-1 and the distributor printer 3-2 of the distributor 4-2 is the delivery company printer 8-11 installed at the delivery company printing base 7-1. Therefore, in this case, the processing unit 115 identifies the record of the delivery company printing base 7-1 from the delivery company management database 125 for the distributor information 1227 of each of the distributors 4-1 and 4-2 in the base identification process.

Further, for example, it is assumed that the distributor information 1227 of each of the distributors 4-1 and 4-3 is identified in the distributor identification process. As described above, the printer whose model is the same as a model of the distributor printer 3-1 of the distributor 4-1 is the delivery company printer 8-11 installed at the delivery company printing base 7-1. In addition, the printer whose model is the same as a model of the distributor printer 3-3 of the distributor 4-3 is the delivery company printer 8-12 installed at the delivery company printing base 7-1 and the delivery company printer 8-22 installed at the delivery company printing base 7-2. For this reason, in this case, the processing unit 115 identifies the record of the delivery company printing base 7-1 for the distributor information 1227 of the distributor 4-1, and identifies the record of the delivery company printing base 7 closest to the address of the advertiser 2A of the delivery company printing bases 7-1 and 7-2 for the distributor information 1227 of the distributor 4-3.

Returning to the description of the flowchart FB, the processing unit 115 generates a sample delivery request notification based on the record identified in the base identification process and the record stored in step SB2 (step SB7).

Here, step SB7 will be described. First, the processing unit 115 generates print data of the print sample SP. In the following description, the print data of the print sample SP will be referred to as “sample print data”.

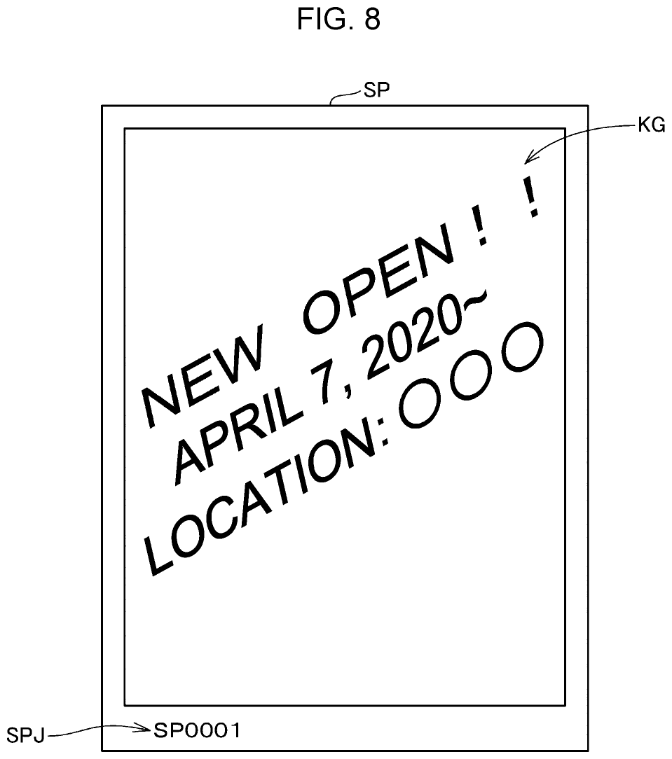

FIG. 8 is a diagram showing an example of the print sample SP. The advertisement image KG indicated by the advertisement image data 1243 of the record identified in step SB2 is printed on the print sample SP. In step SB7, the processing unit 115 generates the sample print data including the advertisement image data 1243 of the record identified in step SB2 and a print command for printing the advertisement image KG indicated by the advertisement image data 1243.

The sample identification information SPJ is printed on the print sample SP. The sample identification information SPJ is printed in the header or the footer of the print sample SP. FIG. 8 shows the case where the sample identification information SPJ is printed in the footer. The processing unit 115 generates the sample identification information SPJ by a predetermined method to generate the sample print data including the generated sample identification information SPJ and the print command for printing the sample identification information SPJ.

Note that the information printed on the print sample SP is merely an example, and may include the name of the distributor 4 who is to distribute the leaflet TS corresponding to the print sample SP, and the manufacturer name, the model name, and the like of the distributor printer 3 of the distributor 4 concerned. Further, a combination of these names may be used as the sample identification information SPJ.

Returning to the description of step SB7, after generating the sample print data, the processing unit 115 generates a sample delivery request notification including the company printing apparatus information 1254 of the record identified by the base identification process, the advertiser address information 1233 associated with the request information ID 1241 of the record stored in step SB2, and the generated sample print data.

In step SB7, when a plurality of records is identified in the base identification process, and the combinations indicated by the company printing apparatus information 1254 of the identified records are different, the processing unit 115 generates a sample delivery request notification for each identified record.

After generating the sample delivery request notification, the processing unit 115 transmits, through the server communication unit 11, the generated sample delivery request notification to the delivery company server 6 installed at the delivery company printing base 7 indicated by the base ID 1252 included in the generated sample delivery request notification (step SB8).

Referring to the flowchart FC, the delivery company server 6 receives the sample distribution request notification from the posting server 1 (step SC1).

Next, the delivery company server 6 causes the delivery company printer 8 indicated by the received sample distribution request notification to issue the print sample SP based on the sample print data included in the received sample distribution request notification (step SC2).

The delivery company server 6 perform a delivery instruction for instructing delivery of the print sample SP issued in step SC2 to the address of the advertiser 2A indicated by the advertiser address information 1233 included in the received sample delivery request notification (step SC3).

For example, in step SC3, the delivery company server 6 transmits information indicating a delivery instruction to the terminal device possessed by the deliverer of the print sample SP. As a result, the print sample SP is delivered to the advertiser 2A by the deliverer.

As mentioned above, the advertisement system 1000 causes the same model printer whose model is the same as a model of the distributor printer 3 of the distributor 4 identified by the identification unit 113 to issue the print sample SP, and delivers the print sample SP issued by the same model printer to the advertiser 2A. For example, when the identification unit 113 identifies the distributor 4-1 the advertisement system 1000 causes the delivery company printer 8-1 which is the same model printer as the distributor printer 3-1 to issue the print sample SP.

As a result, the advertiser 2A can obtain the print sample SP issued by the same model printer, and thus the advertiser 2A can validate the print quality of the leaflet TS to be distributed by the distributor 4.

Next, the operation of the advertisement system 1000 after the print sample SP is delivered to the advertiser 2A will be described separately with respect to when the one print sample SP is delivered to the advertiser 2A, and when the plurality of print sample SPs is delivered to the advertiser 2A.

When the one print sample SP is delivered to the advertiser 2A means when the only one distributor 4 is identified in the distributor identification process, or, when a plurality of the distributors 4 who uses the distributor printer 3 of the same model is identified in the distributor identification process. When a plurality of the print sample SPs is delivered to the advertiser 2A means when a plurality of the distributors 4 who uses the distributor printers 3 of different models is identified in the distributor identification process.

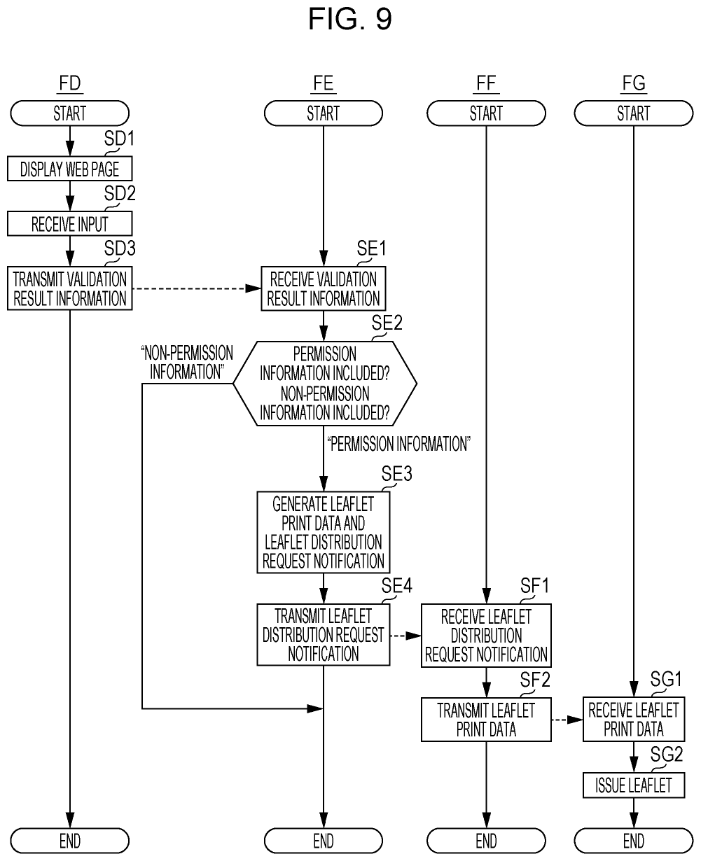

First, the operation when the one print sample SP is delivered to the advertiser 2A will be described. FIG. 9 is a flowchart showing the operation of the advertisement system 1000. In FIG. 9, a flowchart FD shows the operation of the advertiser PC 2. Further, a flowchart FE shows the operation of the posting server 1. Further, a flowchart FF shows the operation of the tablet terminal 5. Further, a flowchart FG shows the operation of the distributor printer 3.

As shown in the flowchart FD, the browser execution unit 2100 of the advertiser PC 2 displays a Web page for inputting information related to the validation result of the print sample SP on the advertiser PC display unit 22 (step SD1).

The browser execution unit 2100 receives the input of the information related to the validation result of the print sample SP on the Web page (step SD2). The advertiser 2A inputs the sample identification information SPJ printed on the delivered print sample SP.

Upon receiving the input, the browser execution unit 2100 transmits the validation result information to the posting server 1 through the advertiser PC communication unit 21 (step SD3).

With reference to the flowchart FE, the second reception unit 112 of the posting server 1 receives the validation result information through the server communication unit 11 (step SE1).

Next, the processing unit 115 determines whether the validation result information received by the second reception unit 112 includes permission information or non-permission information (step SE2).

When it is determined that the non-permission information is included (step SE2: non-permission information), the processing unit 115 does not transmit the leaflet distribution request notification to the distributor 4, and ends the process. That is, the leaflet TS corresponding to the print sample SP distributed to the advertiser 2A is not distributed.

On the other hand, when it is determined that the permission information is included (step SE2: permission information), the processing unit 115 generates the leaflet print data and a leaflet distribution request notification (step SE3).

After generating the sample delivery request notification, the processing unit 115 manages the correspondence relationship between the record identified in step SB2, the distributor information 1227 identified in the distributor identification process, the record identified in the base identification process, and the sample identification information SPJ. Therefore, the processing unit 115 can generate the leaflet print data of the leaflet TS on which the advertisement image KG same as the print sample SP indicated by the sample identification information SPJ is printed based on the sample identification information SPJ included in the validation result information. Further, the processing unit 115 can generate a leaflet distribution request notification to the appropriate distributor 4 based on the sample identification information SPJ included in the validation result information.

Next, the processing unit 115 transmits the generated leaflet distribution request notification to the tablet terminal 5 (step SE4).

With reference to the flowchart FF, the application execution unit 5100 of the tablet terminal 5 receives the leaflet distribution request notification through the terminal network communication unit 51 (step SF1).

Next, the application execution unit 5100 transmits the leaflet print data included in the received leaflet distribution request notification to the distributor printer 3 through the terminal communication unit 52 (step SF2).

With reference to the flowchart FG, the printer controller 30 of the distributor printer 3 receives the leaflet print data through the printer communication unit 31 (step SG1). The printer controller 30 controls the printing unit 32 to perform printing based on the leaflet print data to issue the leaflet TS (step SG2).

For example, it is assumed that the print sample SP issued by the delivery company printer 8-11 which is the same model printer as the distributor printer 3-1 is delivered to the advertiser 2A, and the advertiser 2A permits distribution of the leaflet TS. In this case, the advertisement system 1000 issues, by the distributor printer 3-1 of the distributor 4-1, the leaflet TS on which the advertisement image KG same as the print sample SP delivered to the advertiser 2A is printed.

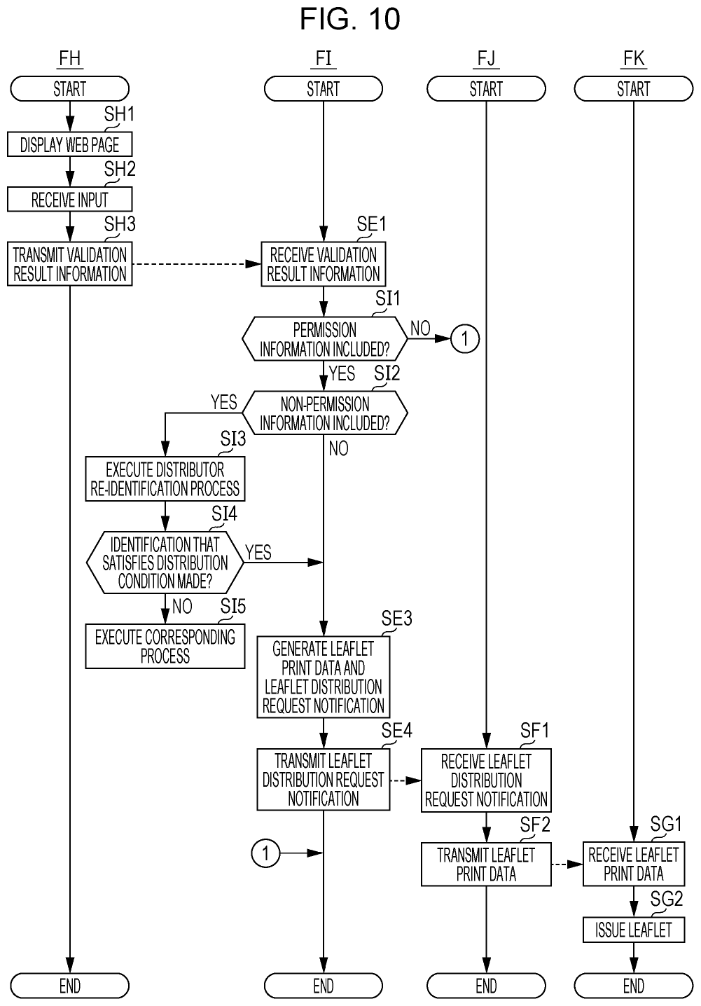

Next, the operation when a plurality of the print sample SPs is delivered to the advertiser 2A will be described. FIG. 10 is a flowchart showing the operation of the advertisement system 1000. In FIG. 10, a flowchart FH shows the operation of the advertiser PC 2. Further, a flowchart FI shows the operation of the posting server 1. Further, a flowchart FJ shows the operation of the tablet terminal 5. Further, a flowchart FK shows the operation of the distributor printer 3.

In the flowchart shown in FIG. 10, the steps same as those in the flowchart shown in FIG. 9 are designated by the same step numbers, and detailed description thereof will be omitted.

As shown in the flowchart FD, the browser execution unit 2100 of the advertiser PC 2 displays a Web page for inputting information related to the validation result of the print sample SP on the advertiser PC display unit 22 (step SH1). The Web page displayed in step SH1 can input the sample identification information SPJ, and permission of the distribution of the leaflet TS or non-permission of the distribution of the leaflet TS for each print sample SP.

The browser execution unit 2100 receives the input of the information related to the validation result of the print sample SP (step SH2).

Upon receiving the input, the browser execution unit 2100 transmits the validation result information indicating the received input to the posting server 1 through the advertiser PC communication unit 21 (step SH3). The validation result information transmitted in step SH3 is associated with the sample identification information SPJ, and the permission information or the non-permission information for each print sample SP.

As shown in the flowchart FI, the processing unit 115 determines whether the validation result information received by the second reception unit 112 includes the permission information (step SI1).

When determining that the validation result information received by the second reception unit 112 does not include the permission information, that is, all the validation result information is the non-permission information (step SI1: NO), the processing unit 115 ends the process without transmitting the leaflet distribution request notification to the distributor 4. That is, the leaflet TS corresponding to any of the print sample SPs delivered to the advertiser 2A is distributed.

On the other hand, when determining that the validation result information received by the second reception unit 112 includes the permission information (step SI1: YES), the processing unit 115 determines whether the validation result information received by the second reception unit 112 includes the non-permission information (step SI2).

When it is determined that the validation result information received by the second reception unit 112 does not include the non-permission information, that is, all the validation result information is the permission information (step SI2: NO), the processing unit 115 executes the processes in step SE3 and the subsequent steps.

As described above, after generating the sample delivery request notification, the processing unit 115 manages the correspondence relationship between the record identified in step SB2, the distributor information 1227 identified in the distributor identification process, the record identified in the base identification process, and the sample identification information SPJ. Therefore, the processing unit 115 can generate the leaflet print data of the leaflet TS on which the advertisement image KG same as the print sample SP indicated by the sample identification information SPJ is printed based on the sample identification information SPJ included in the validation result information. Further, the processing unit 115 can generate a leaflet distribution request notification to the appropriate distributor 4 based on the sample identification information SPJ included in the validation result information.

For example, it is assumed that the print sample SP issued by the delivery company printer 8-11 that is the same model printer as the distributor printer 3-1 and the print sample SP issued by the delivery company printer 8-12 that is the same model printer as the distributor printer 3-3 are delivered to the advertiser 2A, and the advertiser 2A permits delivery of the leaflet TS for both print sample SPs. In this case, the advertisement system 1000 transmits, to the tablet terminal 5-1 of the distributor 4-1, a leaflet distribution request notification including the leaflet print data for instructing the issuance of the leaflet TS on which the advertisement image KG same as the print sample SP issued by the delivery company printer 8-11 is printed. Also, the advertisement system 1000 transmits, to the tablet terminal 5-3 of the distributor 4-3, a leaflet distribution request notification including the leaflet print data for instructing the issuance of the leaflet TS on which the advertisement image KG same as the print sample SP issued by the delivery company printer 8-12 is printed.

On the other hand, when the processing unit 115 determines that the validation result information received by the second reception unit 112 includes the non-permission information (step SI2: YES), the identification unit 113 executes the distributor re-identification process (step SI3).

The distributor re-identification process is a process for identifying the distributor 4 who uses the distributor printer 3 whose model is the same as a model of the distributor printer 3 of the distributor 4 who is to distribute the leaflet TS corresponding to the print sample SP of the sample identification information SPJ with which the permission information is associated, instead of the distributor 4 who is to distribute the leaflet TS corresponding to the print sample SP of the sample identification information SPJ with which the non-permission information is associated. Note that identifying the distributor 4 in the distributor re-identification process is the same as identifying the distributor 4 in the distributor identification process. The distributor 4 who is to distribute the leaflet TS is a distributor who has been identified in the distributor identification process and is a distributor 4 to whom the leaflet distribution request notification is not transmitted.

For example, it is assumed that the distributors 4-1 and 4-2 are identified by the distributor identification process, and the print sample SP issued by the delivery company printer 8-11 and the print sample SP issued by the delivery company printer 8-12 are delivered to the advertiser 2A. It is assumed that while the advertiser 2A permits the distribution of leaflet TS for the print sample SP issued by the delivery company printer 8-11, the advertiser 2A does not permit the distribution of the leaflet TS for the print sample SP issued by the delivery company printer 8-12. In this case, the identification unit 113 performs the distributor re-identification process to identify the distributor information 1227 of the distributor 4-2 using the distributor printer 3-2 whose model is the same as a model of the delivery company printer 8-1, instead of the distributor information 1227 of the distributor 4-3.

In the distributor re-identification process, the distributor information 1227 that satisfies the distribution condition of the record identified in step SB2 is identified based on the distributor information 1227 of the distributor 4 who is to distribute the leaflet TS corresponding to the print sample SP of the sample identification information SPJ with which the permission information is associated.

As described above, after generating the sample delivery request notification, the processing unit 115 manages the correspondence relationship between the record identified in step SB2, the distributor information 1227 identified in the distributor identification process, the record identified in the base identification process, and the sample identification information SPJ. Therefore, the processing unit 115 can appropriately perform the process of step SI2.

The processing unit 115 determines whether the IDENTIFICATION THAT SATISFIES THE DISTRIBUTION CONDITION IS MADE (step SI4).

When it is determined that the identification that satisfies the distribution condition is not made (step SI4: NO), the processing unit 115 performs the corresponding process (step SI5). An example of the corresponding process includes a process of notifying the advertiser 2A that the leaflet TS that meets the distribution condition cannot be distributed.

On the other hand, when the identification unit 113 determines that the distributor information 1227 satisfying the distribution condition is identified by the distributor re-identification process (step SI4: YES), the processing unit 115 executes the processes of step SE3 and subsequent steps.

For example, it is assumed that the distributors 4-1 and 4-2 are identified by the distributor identification process, and the print sample SP issued by the delivery company printer 8-11 and the print sample SP issued by the delivery company printer 8-12 are delivered to the advertiser 2A. It is assumed that while the advertiser 2A permits the distribution of leaflet TS for the print sample SP issued by the delivery company printer 8-11, the advertiser 2A does not permit the distribution of the leaflet TS for the print sample SP issued by the delivery company printer 8-12. It is assumed that the identification unit 113 performs the distributor re-identification process to identify the distributor information 1227 of the distributor 4-2 using the distributor printer 3-2 whose model is the same as a model of the delivery company printer 8-1, instead of the distributor information 1227 of the distributor 4-3. In this case, the advertisement system 1000 transmits, to the tablet terminal 5-1 of the distributor 4-1, a leaflet distribution request notification including the leaflet print data for instructing the issuance of the leaflet TS on which the advertisement image KG same as the print sample SP issued by the delivery company printer 8-11 is printed. Also, the advertisement system 1000 transmits, to the tablet terminal 5-2 of the distributor 4-2, a leaflet distribution request notification including the leaflet print data for instructing the issuance of the leaflet TS on which the advertisement image KG same as the print sample SP issued by the delivery company printer 8-11 is printed.

As mentioned above, the advertisement system 1000 that issues the leaflet TS by the distributor printer 3 of the distributor 4 distributing the leaflet TS on which the advertisement image KG is printed includes the processing unit 115 that causes the same model printer to issue the print sample SP on which the advertisement image KG is printed as a sample of the leaflet TS, and that delivers the print sample SP issued by the same model printer to the advertiser 2A.

The method of controlling the advertisement system 1000 includes causing the same model printer to issue the print sample SP on which the advertisement image KG is printed as a sample of the leaflet TS, and delivering the print sample SP issued by the same model printer to the advertiser 2A.

The posting server 1 includes the processing unit 115 that causes the same model printer to issue a print sample SP on which the advertisement image KG is printed as a sample of the leaflet TS, and that transmits a requests for delivering the print sample SP issued by the same model printer to the advertiser 2A.

According to the advertisement system 1000, the method of controlling the advertisement system 1000, and the posting server 1, the advertiser 2A can obtain the print sample SP issued by the delivery company printer 8 having the same model as the distributor printer 3 of the distributor 4 that distributes the leaflet TS, so that the advertiser 2A can validate the print quality of the leaflet TS to be distributed by the distributor 4.

The processing unit 115 delivers the print sample SP to the advertiser 2A before the distributor 4 starts distributing the leaflet TS.

According to this, the advertiser 2A can validate the print quality of the leaflet TS to be distributed by the distributor 4 before the distributor 4 starts distributing the leaflet TS.

The same model printer is installed at the delivery company printing base 7 different from the distributor printing base 4A at which the distributor printer 3 is installed.

According to this, the advertiser 2A can validate the print quality of the leaflet TS to be distributed by the distributor 4 even when the same model printer is installed at a base different from the distributor printing base 4A.

A plurality of the delivery company printers 8 is installed at the delivery company printing base 7. The processing unit 115 identifies the same model printer from the plurality of delivery company printers 8 installed at the delivery company printing base 7 to cause the same model printer to issue the print sample SP.

According to this, even when the plurality of delivery company printers 8 is installed at the delivery company printing base 7, the delivery company printer 8 whose model is the same as a model of the distributor printer 3 can issue the print sample SP. Therefore, the advertiser 2A can validate the print quality of the leaflet TS to be distributed by the distributor 4 even in the configuration in which the plurality of delivery company printers 8 is installed at the delivery company printing base 7.

When there is the plurality of delivery company printing bases 7, the processing unit 115 identifies the delivery company printing base 7 closest to the address of the advertiser 2A.

According to this, the time required until the print sample SP is delivered to the advertiser 2A can be shortened. Therefore, the advertiser 2A can quickly validate the print quality of the print sample SP after making the advertisement request. Further, since the advertiser 2A can quickly validate the print quality of the print sample SP, the advertisement system 1000 can reduce the time required from the advertisement request by the advertiser 2A to the distribution of the leaflet TS.

The advertisement system 1000 includes the server storage unit 120 that stores the distributor information 1227 about the distributor 4, the first reception unit 111 that receives an advertisement request including a distribution condition related to a distribution of the leaflet TS from the advertiser 2A, and the identification unit 113 that identifies, based on the distributor information 1227 stored in the server storage unit 120, the distributor 4 that satisfies the distribution condition included in the advertisement request received by the first reception unit 111. The processing unit 115 causes the delivery company printer 8 whose model is the same as a model of the distributor printer 3 of the distributor 4 identified by the identification unit 113 to issue the print sample SP.

According to this, since the distributor 4 that meets the distribution condition of the advertiser 2A is automatically identified, the advertiser 2A can validate the print quality of the leaflet TS distributed by the distributor 4 that meets the distribution condition of the advertiser 2A.

When the identification unit 113 identifies the plurality of distributors 4 each having a different model of the distributor printer 3, the processing unit 115 causes a plurality of the same model printers to each issue the print sample SP on which the advertisement image KG and the sample identification information SPJ are printed to request for delivering the plurality of respective print sample SPs to the advertiser 2A.

According to this the plurality of print sample SPs is issued by a plurality of the same model printers of different models, and even when the plurality of print sample SPs is distributed to the advertiser 2A, the advertiser 2A can validate the print quality of the leaflet TS by identifying each print sample SP.

The advertisement system 1000 includes the second reception unit 112 that receives, from the advertiser 2A, permission of a distribution of the leaflet TS or non-permission of a distribution of the leaflet TS for each print sample SP distributed to the advertiser 2A. When the second reception unit 112 receives the permission and the non-permission of the plurality of the print samples SP distributed to the advertiser 2A, the identification unit 113 identifies the distributor 4 who uses the distributor printer 3 whose model is the same as a model of the distributor printer 3 of the distributor 4 who is to distribute the leaflet TS corresponding to the print sample SP which is permitted to distribute, instead of the distributor 4 who is to distribute the leaflet TS corresponding to the print sample SP which is not permitted to distribute.

According to this, the print quality of the leaflet TS to be distributed can conformed to the print quality of the print sample SP that the advertiser 2A has validated and permitted to distribute. Therefore, the advertisement system 1000 can reliably distribute the leaflet TS with the print quality accepted by the advertiser 2A.

The embodiment described above is merely an aspect of the present disclosure, and any modification and application can be made within the scope of the present disclosure.

Further, for example, the distributor printer 3 and the delivery company printer 8 are not limited to a serial type ink jet printer, and may be a line type ink jet printer. The printing method is not limited to the ink jet method.

Further, the functions of the server controller 10, the advertiser PC controller 20, the terminal controller 50, and the printer controller 30 may be implemented by a plurality of processors or semiconductor chips.

Further, respective units shown in FIGS. 2A to 2C are an example, and a specific mounting form is not limited in particular. That is, it is not necessarily required to implement hardware corresponding to respective units, but it is of course possible to construct a configuration in which the functions of the respective units are implemented by executing a program by one processor. In addition, in the above embodiments, part of the functions implemented by software may be implemented by hardware, or part of the functions implemented by hardware may be implemented by software. In addition, specific detailed configurations of other units of the posting server 1, the advertiser PC 2, the tablet terminal 5, and the distributor printer 3 can be changed in any manner without departing from the scope of the present disclosure.

Further, for example, the step units of the operations shown in FIGS. 7, 9, and 10 are divided in accordance with the main processing contents in order to facilitate understanding of the operations of the respective devices of the advertisement system 1000. The present disclosure is not limited by the method and name of the division of the processing stage. Depending on the processing contents, the process may be divided into more step units. Further, one step unit may be divided so as to include more processes. In addition, the order of the steps may be changed as appropriate within the scope of the present disclosure.

What is claimed is:

1. An advertisement system that issues an advertising medium by a first printing apparatus of a distributor who distributes the advertising medium on which an advertisement image is printed, the advertisement system comprising:
a server that causes a same model printing apparatus whose model is the same as a model of the first printing apparatus to issue, as a sample of the advertising medium, printed matter on which the advertisement image is printed, the server transmits a requests for delivering the printed matter issued by the same model printing apparatus to an advertiser.

2. The advertisement system according to claim 1, wherein
the server transmits a requests for delivering the printed matter to the advertiser before the distributor starts distributing the advertising medium.

3. The advertisement system according to claim 1, wherein
the same model printing apparatus is installed at a second base different from a first base where the first printing apparatus is installed.

4. The advertisement system according to claim 3, wherein
a plurality of second printing apparatuses is installed at the second base, and wherein
the server identifies the same model printing apparatus from the plurality of second printing apparatuses installed at the second base to cause the same model printing apparatus to issue the printed matter.

5. The advertisement system according to claim 4, wherein
when there is a plurality of the second bases each of which the same model printing apparatus is installed at, the server identifies the second base closest to a location of the advertiser.

6. The advertisement system according to claim 1, wherein
the server includes
a storage unit that stores distributor information about the distributor, and
a first reception unit that receives, from the advertiser, an advertisement request including a distribution condition related to a distribution of the advertising medium, and wherein
the server identifies, based on the distributor information stored in the storage unit, the distributor who satisfies the distribution condition included in the advertisement request received by the first reception unit to cause the same model printing apparatus whose model is the same as a model of the first printing apparatus of the identified distributor to issue the printed matter.

7. The advertisement system according to claim 6, wherein
when the identification unit identifies the plurality of distributors each having a different model of the first printing apparatus, the server causes a plurality of the same model printing apparatuses to each issue the printed matter on which the advertisement image and identification information of the printed matter are printed, the server transmitting a requests for delivering a plurality of pieces of the printed matter to the advertiser.

8. The advertisement system according to claim 7, wherein
the server includes
a second reception unit that receives, from the advertiser, permission of a distribution of the advertising medium or non-permission of a distribution of the advertising medium for each of the plurality of pieces of the printed matter distributed to the advertiser, and wherein
when the second reception unit receives the permission or the non-permission for each of the plurality of pieces of the printed matter distributed to the advertiser, the server identifies the distributor who uses the first printing apparatus whose model is the same as a model of the first printing apparatus of the distributor who is to distribute the advertising medium corresponding to the printed matter which is permitted to distribute, instead of the distributor who is to distribute the advertising medium corresponding to the printed matter which is not permitted to distribute.

9. A method of controlling an advertisement system for issuing an advertising medium by a first printing apparatus of a distributor who distributes the advertising medium on which an advertisement image is printed, the method comprising:
causing a same model printing apparatus whose model is the same as a model of the first printing apparatus to issue, as a sample of the advertising medium, printed matter on which the advertisement image is printed; and
delivering the printed matter issued by the same model printing apparatus to an advertiser.

10. A server that causes a first printing apparatus of a distributor who distributes an advertising medium on which an advertisement image is printed to issue the advertising medium, wherein
the server causes a same model printing apparatus whose model is the same as a model of the first printing apparatus to issue, as a sample of the advertising medium, printed matter on which the advertisement image is printed, and transmits a requests for delivering the printed matter issued by the same model printing apparatus to an advertiser.
